(19) United States
(12) Patent Application Publication
(10) Pub. No.: US 2021/0005181 A1
(43) Pub. Date: Jan. 7, 2021

(54) AUDIBLE KEYWORD DETECTION AND METHOD

(71) Applicant: Knowles Electronics, LLC, Itasca, IL (US)

(72) Inventors: Adam Abed, Sunnyvale, CA (US); Sib Sankar Dey, Cupertino, CA (US); Sharon Gadonniex, Arlington, MA (US); Matthew Cowan, San Jose, CA (US); Karthigeyan Vaidyanathan, Bangalore (IN); Douglas Vargha, Menlo Park, CA (US)

(21) Appl. No.: 16/892,693

(22) Filed: Jun. 4, 2020

(30) Foreign Application Priority Data
Jun. 10, 2019 (IN) 201911022998

(51) Int. Cl. G10L 15/08; G10L 15/28; G06F 1/324; G06F 1/3206

(52) U.S. Cl. CPC G10L 15/08; G10L 15/285; G10L 2015/088; G06F 1/3206; G06F 1/324

(57) ABSTRACT

The disclosure describes keyword detection in an audio processor and methods therefor including a low-power keyword detection engine (LKDE) and a high-power keyword detection engine (HKDE). In one implementation, the LKDE detects a keyword in data from a single audio source while buffering data from multiple audio sources and, upon detection of a keyword, the HKDE is awakened to verify the previously detected keyword by processing the buffered audio data from the multiple sources.

### FIELD OF THE DISCLOSURE

The present disclosure relates generally to audible keyword detection and more specifically to processors, microphone assemblies, and other systems implementing keyword detection, and methods therein.

### BACKGROUND

A microphone converts sound, via a transducer, into an electrical signal that represents the sound. It is also known generally to process the electrical signal to determine whether the sound includes a spoken keyword. Conventional keyword detection processors require high processing power due to the intensive signal processing required to achieve a good true positive rate (TPR) (e.g., the rate of detection where the keyword was actually spoken) and a low false acceptance rate (FAR) (e.g., the rate of detection where the device detects the keyword but the keyword was not actually spoken). Far-field conditions and high noise conditions will increase the computational load and power consumption. However, while the high-power determination increases the true positive rate, it utilizes a substantial amount of power and processing resources, and may not be suitable in applications where such power and resources are limited, such as mobile and other battery-powered applications.

### BRIEF DESCRIPTION OF THE DRAWINGS

The objects, features and advantages of the present disclosure will become more fully apparent from the following description and appended claims, taken in conjunction with the accompanying drawings. The drawings depict only representative embodiments and are therefore not considered to limit the scope of the disclosure, the description of which includes additional specificity and detail.

FIG. 1 is a block diagram of a system implementing keyword detection.

FIG. 2 is a state diagram for keyword detection in a processor.

FIG. 3 is a keyword detection flow diagram.

FIG. 4 is cross-sectional view of a microphone assembly.

### DETAILED DESCRIPTION

The present disclosure describes devices and methods for audible keyword detection having improved computational and power efficiency, a high TPR, and a low FAR. FAR includes a false recognition rate (FRR), imposter acceptance rate (IAR) and a spoof acceptance rate (SAR) among others. Such keyword detection is implemented in processors, microphones, and other systems, and is suitable for mobile devices and other battery-powered applications.

The keyword detection engine generally comprises a low-power keyword detection engine (LKDE) and a high-power keyword detection engine (HKDE) implementable in an audio processor (e.g., a DSP) or other hardware device. The LKDE and HKDE may be implemented as code (e.g., software, firmware . . . ) executable by a processor. The LKDE determines whether audio data obtained from at least one source (e.g., a microphone) contains a keyword while the audio data is buffered. Keyword detection by the LKDE may be based on a confidence with which detection occurred or on other criterion. For example, detection of a keyword may be deemed to have occurred when a confidence level or factor satisfies a condition relative to a reference. Such a reference may be fixed and or a function of one or more changing contextual conditions, like background noise. Hardware implementable schemes for detecting the likely presence of a keyword based on confidence among other keyword detection methodologies are known generally and further discussed to only a limited extent herein.

The keyword detection engine also includes a high-power keyword detection engine (HKDE) that is activated (e.g., awaken from a low-power sleep mode) if or when the LKDE detect likely presence of a keyword. After awakening, the HKDE verifies the likely presence of the keyword previously detected by the LKDE by processing data in the buffer. Generally the HKDE is configured to detect keywords with more accuracy or certainty than the LKDE. In one implementation for example, the LKDE determines likely presence of a keyword with a TPR above a first threshold and a FAR below a second threshold, wherein the first and second thresholds are constrained by a maximum acceptable power consumption associated with a duty cycle with which the HKDE is awakened. The HKDE is configured to determine likely presence of the keyword with a lower FAR than the LKDE.

To achieve greater keyword detection accuracy, the HKDE may implement a similar but more complex keyword detection technique than the LKDE. Alternatively, the HKDE may implement a different keyword detection technique than the LKDE. The HKDE may also use supplemental processing schemes to improve the detection accuracy or reliability. For example, the HKDE may use complex mathematical probability maps, directional noise suppression, like beamforming, or other noise cancellation or suppression techniques, and/or other processing schemes in combination with a keyword detection algorithm. In the present disclosure, verification of the keyword by the HKDE means to detect the keyword with a higher certainty or accuracy than the LKDE.

The memory, processing and power requirements of the LKDE are generally less than that of the HKDE. According to one aspect of the disclosure, keyword detection by the LKDE, is performed in a relatively low power mode of operation compared to a relatively high power mode of operation during which the HKDE operates. The HKDE generally remains in a low power sleep mode unless and until a keyword is detected by the LKDE. In some implementations, the LKDE is always ON and the HKDE is always OFF in the low power mode of operation. According to a related aspect of the disclosure, keyword detection by the HKDE is performed in a relatively high power mode of operation.

In some embodiments, buffering of data and operation of the LKDE continues during the high power mode during which the HKDE operates. Such operation ensures ongoing detection of keywords in audio data received while the HKDE is verifying a previously detected keyword and prevents unnecessary OFF/ON cycling of the HKDE. Operation of the LKDE may be limited to a fixed or variable duration after awakening the HKDE or the LKDE may operate continuously. The HKDE may also remain awake for a specified duration after an unsuccessful keyword verification attempt. The durations during which the LKDE and HKDE remain operational are generally different and may be a function of context, like noise level, connection to supplemental power, among others.

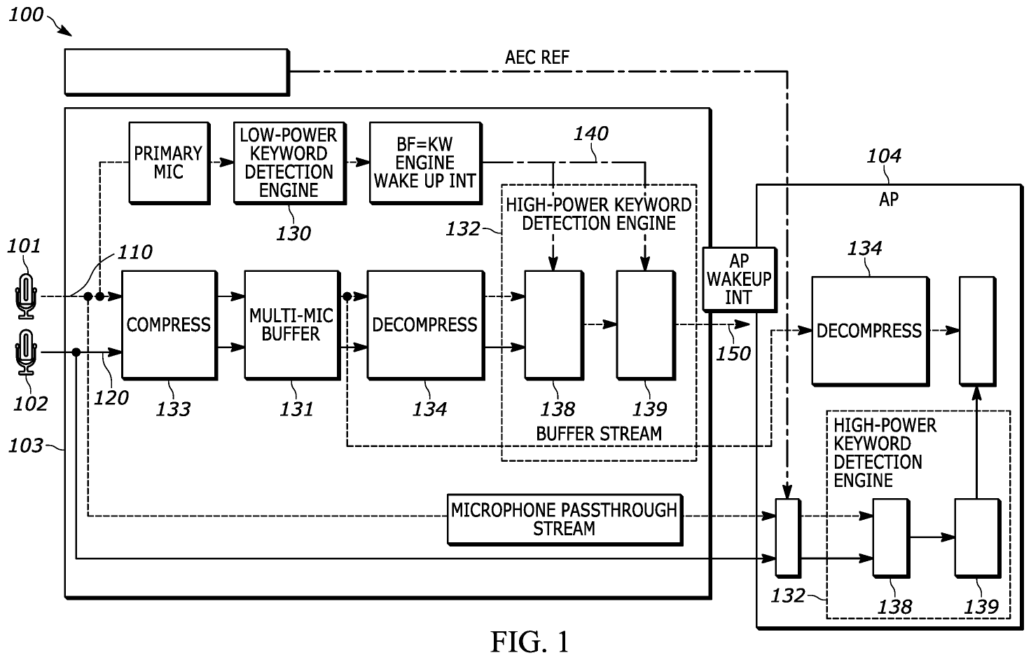

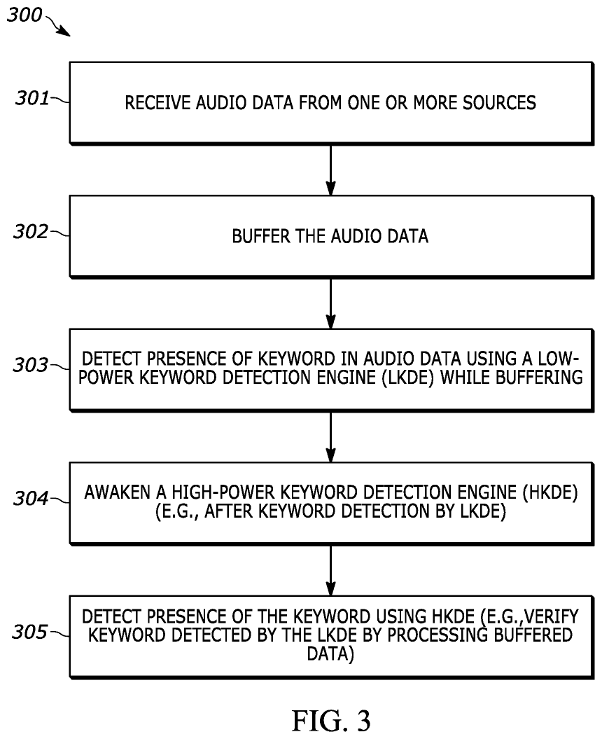

FIG. 1 is a block diagram of an example system 100 in which keyword detection is employed. The system comprises generally a first microphone 101, a second microphone 102, a first processor 103 that performs keyword detection, and a host device processor 104. The microphones 101 and 102 generate corresponding audio signals 110 and 120, representative of detected sound, input to the processor. In alternative embodiments, the processor processes inputs from only a single microphone or from more than two microphones. The audio signals processed by the processor are digital. Conversion of analog signals to digital data occurs prior to keyword detection, for example at a digital microphone or some other device that converts analog signals to digital. Thus the audio signals or data referred to herein are digital (e.g., PCM data) unless specified otherwise. FIG. 3 is an example method 300 of implementing the keyword detection system. At 301, a processor receives audio data at least from at least one source, for example the microphone 101 in FIG. 1.

In FIG. 1, the first processor 103 includes a low-power keyword detection engine (LKDE) 130, a buffer 131, and a high-power keyword detection engine (HKDE) 132. While the low and high power blocks are shown separately, they are merely representative of different functions implemented by the processor. Such functionality may be implemented upon execution of computer-executable code stored in a memory device of, or associated with, the processor. Alternatively, this functionality may be implemented in equivalent hardware or in a combination of hardware and software. In some embodiments, the host device 104 implements its own keyword detection engine to further verify keywords detected by the processor 103 upon being awakened by the processor 103. In other implementations, the host device performs no additional keyword verification.

In FIG. 1, the buffer 13 is coupled to an audio data interface of the processor 103 into which audio data from one or more microphones or other sources are input. In FIG. 3, at 302, the processor buffers audio data received from the one or more sources. In some embodiments, optionally, the one or more audio signals are compressed in a compression block 133 before buffering and decompressed in a decompression block 134 after buffering. The compression block may be any algorithm or signal processing device that compresses or reformats incoming audio signals to reduce required buffer or memory resources. Similarly, the decompression block may be any algorithm or signal processing device that decompresses or reformats audio signals output from the buffer.

The buffer has limited capacity and stores audio data for a specified time period before overwriting previously stored data in a first-in first-out fashion. In some implementations, keyword detection by the LKDE is always ON and data is buffered continuously. In others, LKDE may pause unless awaken by some event like an acceleration of the processor or host device, a noise, contextual event, etc. after which keyword detection is enabled until expiration of time out period after which no further voice or other enabling activity is detected. An acoustic activity detector (AAD) or accelerometer could be used for this purpose. However, continuous buffering and operation of the LKDE in an always-on mode will decrease the chance that keywords will not be detected.

Generally, the LKDE determines whether a keyword is present in the audio data while the audio data is buffered in the buffer, as shown at 303 in FIG. 3. The LKDE determines whether a keyword is present based on whether a confidence level associated with detection of the keyword satisfies a condition. While the process in FIG. 3 shows buffering occurring before keyword detection, these steps are performed concurrently or at least overlap temporally to some extent. In one embodiment, the LKDE processes only one audio signal (e.g., audio signal 110 of the first microphone 101 in FIG. 1) for keywords to minimize the computational burden and power consumption. Alternatively, the LKDE may adaptively process more than one audio signal based on context. Such context may include for example, background noise being above some threshold or the processor or host device being connected to a supplemental power source (e.g., connected to a car charger), among others. The LKDE may revert to processing only a single audio signal when a change in context permits.

Generally, the HKDE is awakened from a sleep mode after the LKDE detects a keyword in the audio data, as shown at 304 in FIG. 3. Upon awakening, the HKDE determines or verifies likely presence of a keyword previously detected by the LKDE by processing data in that was buffered during keyword detection by the LKDE, as shown at 305 in FIG. 3. In implementations where audio data from multiple sources is buffered, the HKDE determines likely presence of the keyword previously detected by the LKDE by processing buffered data from multiple sources. Processing data from multiple sources enables the HKDE to implement noise suppression or other higher order keyword detection with more accuracy than the LKDE.

In some implementations, however, the HKDE may be awakened without prior keyword detection by the LKDE based on context. Such context may be when a background noise is above a threshold in which the LKDE may detect a keyword, or when the processor or host is connected to supplemental power, among other situations. Thus, in some situations, the HKDE is awakened from a low power sleep mode and determines likely presence of a keyword in the audio data, without detection by the LKDE in the first instance. The HKDE generally performs keyword detection by processing data from multiple audio sources, but there may be situations where data from only one source is processed. Also, in implementations where the processor wakes a host device upon detection of a keyword by the HKDE, the audio data may be buffered while the HKDE determines the presence of the keyword. Thus, upon awakening the host device, the buffered data may be ported to the host for further processing (e.g., verification of the keyword detected by the HKDE, stitching of the buffered data to real time data etc.). The processor may implement this mode of operation by monitoring one or more preliminary conditions (e.g., using a noise detection algorithm, external power detection algorithm, etc.). In this implementation, the LKDE is enabled only if the preliminary condition (e.g., noise level below a threshold, lack of external power, etc.) is satisfied. Otherwise, the HKDE is enabled without prior detection of a keyword by the LKDE.

FIG. 1 shows the HKDE wakeup signal communicated from the LKDE, but in other embodiments the wakeup signal may be communicated to the HKDE by some other circuit or algorithm (e.g., a noise classifier or external power detector) the processor.

In some implementations, an interrupt or wakeup signal 150 is communicated from the processor 103 to the host device 104 upon verification of the keyword by the HKDE. The wakeup signal prompts the host to receive and process real time audio signals from the processor. In some implementations the host also receives and processes buffered data from the processor.

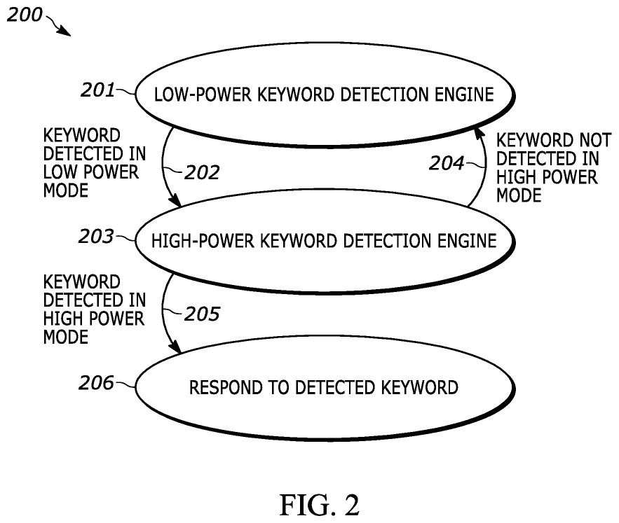

FIG. 2 is a schematic state diagram of a processor that implements keyword detection. In a first state 201, the LKDE searches for keywords in an audio signal while the audio data is buffered. The HKDE is in a sleep mode during which the HKDE does not process audio data. The HKDE sleep mode may be controlled by application of a slower clock speed and/or other means known in the art. A first transition 202 is made from the first state 201 to a second state 203 after the LKDE detects a keyword or upon some other condition prompting the HKDE to awaken, examples of which are discussed herein. In the second state 203, depending on the circumstances on which the HKDE was awakened, the HKDE attempts to detect a keyword in the buffered data from one or more audio signals to verify the presence of a keyword previously detected by the LKDE or the HKDE detects a keyword in audio data from one or more source while buffering the data. In some embodiments, a second transition 205 is made from the second state 203 to a third state 206 upon verification or detection of a keyword by the HKDE. The third state may have a higher power level than the first and second states. If the HKDE cannot verify a keyword previously detected by the LKDE or detect a keyword, the processor transitions 204 back to the first state 201. As suggested, in some embodiments, the HKDE remains in the second state 303 for some period of time before transitioning back to state 201. In some embodiments, the LKDE identifies an approximate location of the detected keyword in the buffered data to facilitate verification by the KHDE, thereby reducing the time required for verification and associated power consumption. The keyword location may be specific by a time stamp or other indicia. The processor may similarly identify the location of the keyword for the host.

In some embodiments, the first processor 103 has a local oscillator from which a clock signal is obtained or derived for clocking the processor. Alternatively, the processor is clocked by an external clock. In some embodiments wherein the processor is integrated or operates with a host device, the processor is clocked by a local clock when the host is asleep and the processor is clocked by an external clock signal provided to the processor by the host or other source after the host device is awakened. The external clock signal may be applied to an external interface of the processor or to an external interface of a device (e.g., a microphone) in which the processor is integrated.

Generally, the processor or other device performing keyword detection may be integrated in some other device like a microphone assembly, an ear-worn hearable device, a portable communication device, a gaming handset, among many other electronic or Internet of Things (IoT) devices or hosts.

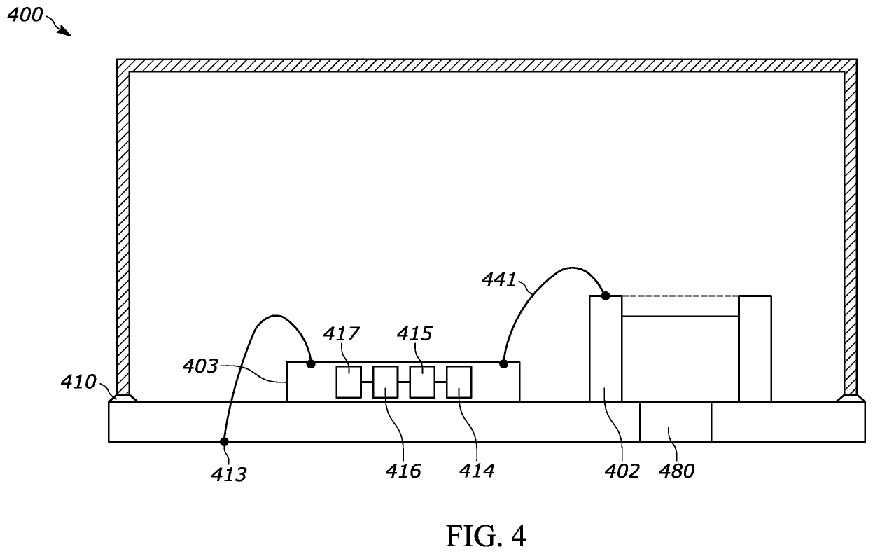

FIG. 4 depicts a cross-sectional view of a microphone assembly 400 in which an processor implementing keyword detection is integrated, generally including an electro-acoustic transducer 402 coupled to an electric circuit 403 disposed within a housing 410. The transducer may be a microelectromechanical systems (MEMS) transducer or other transducer. The electrical circuit may be embodied by one or more integrated circuits, for example, an ASIC with analog and digital circuits and a discrete digital signal processor (DSP) that performs keyword detection. The housing 410 may include a sound port 480 and a external device interface 413 with contacts (e.g., for power, data, ground, control, external signals etc.) to which the electrical circuit is coupled. The external device interface is configured for surface or other mounting to a host device (e.g., by reflow soldering).

In FIG. 4, the electric circuit receives an electrical signal generated by the electro-acoustic transducer via connection 441. The electric circuit may include a A/D converter 414, a buffer 415, a low-power keyword detection engine (LKDE) 416, and a high-power keyword detection engine (HKDE) 417. The buffer is coupled to the converter and buffers the digital data. As discussed herein, the LKDE determines whether a keyword is likely present in the digital data. The HKDE wakes up in response to the LKDE determining the presence of the keyword above a confidence level. The HKDE then verifies the presence of the keyword in the digital data by processing the buffered digital data in the buffer. As explained, the HKDE detects the presence of the keyword with a higher degree of certainty than the LKDE.

In one microphone assembly implementation, an interface of the microphone assembly includes an electrical contact connectable to a second microphone assembly, wherein the electrical circuit is configured to receive digital data representative of a second electrical signal generated by a second microphone assembly. In this implementation, the LKDE is configured to detect presence of a keyword by processing digital data representative of not more than one of the electrical signal generated by the transducer 402 or the second electrical signal while buffering digital data representative of both the electrical signal and the second electrical signal in the buffer, and the HKDE is configured to verify presence of a keyword by processing buffered digital data representative of both the electrical signal from the transducer 402 and the second electrical signal from the second microphone assembly.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A digital processor for processing audio data, the processor comprising:
an audio data interface;
a buffer coupled to the interface and configured to buffer data received at the interface;
a low-power keyword detection engine (LKDE) configured to determine likely presence of a keyword in data received at the interface while the data is buffered in the buffer; and
a high-power keyword detection engine (HKDE) configured to wakeup from a low-power sleep mode if the LKDE determines likely presence of a keyword, and after awakening, verify the likely presence of the keyword detected by the LKDE by processing data in the buffer,
wherein the HKDE is configured to detect keywords with higher certainty than the LKDE.

2. The processor of claim 1,
wherein the LKDE is configured to determine likely presence of a keyword with a true positive rate (TPR) above a first threshold and a false acceptance rate (FAR) below a second threshold, wherein the first and second thresholds are constrained by a maximum acceptable power consumption associated with a duty cycle with which the HKDE is awakened, and
wherein the HKDE is configured to detect likely presence of a keyword with a lower FAR than the LKDE.

3. The processor of claim 2, wherein the LKDE is configured to determine likely presence of a keyword based on whether a confidence level associated with detection of the keyword satisfies a condition.

4. The processor of claim 2,
the interface is a multi-source interface and the buffer is configured to buffer data received from multiple sources,
the LKDE is configured to determine likely presence of a keyword by processing data from not more than a single source while data received from multiple sources is buffered in the buffer, and
the HKDE is configured to verify likely presence of a keyword detected by the LKDE by processing buffered data from multiple sources.

5. The processor of claim 4, wherein the HKDE is configured to process buffered data from multiple sources by implementing a spatially selective noise suppression algorithm.

6. The processor of claim 1, wherein the LKDE is configured to determine likely presence of a keyword only if a preliminary condition is satisfied, and wherein the HKDE is configured to wakeup from the low-power sleep mode and determine likely presence of a keyword in data received at the interface while the data is buffered in the buffer if the preliminary condition is not satisfied.

7. The processor of claim 6, wherein the preliminary condition is a noise level below a threshold or a supply of battery-power to the processor.

8. The processor of claim 4 further comprising an external device interface, wherein the processor is configured to provide an external device wakeup signal, the buffered data, and real-time data from the multiple sources to the external device interface only after the HKDE verifies the presence of the keyword.

9. A microphone assembly comprising:
a housing having a sound port and an external device interface with electrical contacts;
an electro-acoustic transducer disposed in the housing and configured to generate an electrical signal in response to detecting acoustic energy; and
an electrical circuit disposed in the housing and electrically coupled to contacts of the external device interface, the electrical circuit comprising:
a converter configured to convert the electrical signal to digital data;
a buffer coupled to the converter and configured to buffer the digital data;
a low-power keyword detection engine (LKDE) configured to detect presence of a keyword in the digital data while the digital data is buffered in the buffer; and
a high-power keyword detection (HKDE) configured to wakeup from a low-power sleep mode if the LKDE detects a keyword in the digital data, and after awakening verify presence of a keyword detected by the LKDE by processing the digital data in the buffer,
wherein the HKDE is configured to detect keywords with higher certainty than the LKDE.

10. The assembly of claim 9,
wherein the LKDE is configured to detect presence a keyword with a true positive rate (TPR) above a first threshold and a false acceptance rate (FAR) below a second threshold,
wherein the first and second thresholds are constrained by a maximum acceptable power consumption associated with a duty cycle with which the HKDE is awakened, and
wherein the HKDE is configured to detect presence of a keyword with a lower FAR than the LKDE.

11. The assembly of claim 10, wherein the LKDE is configured to detect presence of a keyword based on whether a confidence level of detection satisfies a condition.

12. The assembly of claim 9,
the external device interface including an electrical contact connectable to a second microphone assembly,
the electrical circuit configured to receive digital data representative of a second electrical signal generated by a second microphone assembly,
the LKDE configured to detect presence of a keyword by processing digital data representative of not more than one of the electrical signal or the second electrical signal while buffering digital data representative of both the electrical signal and the second electrical signal in the buffer, and
the HKDE is configured to verify presence of a keyword by processing buffered digital data representative of both the electrical signal and the second electrical signal.

13. The assembly of claim 12, wherein the HKDE is configured to process the buffered digital data by implementing a spatially selective noise suppression algorithm.

14. The assembly of claim 12,
wherein the LKDE is configured to detect presence of a keyword with a true positive rate (TPR) above a first threshold and a false acceptance rate (FAR) below a second threshold,
wherein the first and second thresholds are constrained by a maximum acceptable power consumption associated with a duty cycle with which the HKDE is awakened, and
wherein the HKDE is configured to detect presence of a keyword with a lower FAR than the LKDE.

15. The assembly of claim 9, wherein the electrical circuit is configured to provide a host device wakeup signal, the buffered digital data, and real-time digital data representative of the electrical signal to the external device interface only after the HKDE verifies presence of a keyword detected by the LKDE.

16. The assembly of claim 15, the electrical circuit further comprising a local oscillator, wherein the electrical circuit is configured to be clocked by the local oscillator before the electrical circuit provides the host device wakeup signal to the host device interface.

17. The assembly of claim 16, the external device interface including an external clock contact, wherein the electrical circuit is configured to be clocked by an external clock signal received at the external clock contact after the electrical circuit provides the wakeup signal to the external device interface.

18. A method for detecting a keyword in an audio processor, the method comprising:
receiving audio data from at least one source;
buffering the audio data;
determining whether the audio data includes a keyword using a low-power keyword detection engine (LKDE) while buffering;
awakening a high-power keyword detection engine (HKDE) from a low-power sleep mode if a keyword is detected by the LKDE; and
verifying presence of the keyword detected by the LKDE by processing buffered audio data using the HKDE,
wherein the LKDE is configured to determine presence of the keyword with a true positive rate (TPR) above a first threshold and a false acceptance rate (FAR) below a second threshold, the first and second thresholds being constrained by a maximum acceptable power consumption associated with a duty cycle with which the HKDE is awakened, and wherein the HKDE is configured to detect presence of the keyword with a lower FAR than the LKDE.

19. The method of claim 18, further comprising:
receiving audio data from multiple sources;
determining whether the audio data includes a keyword by processing audio data from not more than one source using the LKDE while buffering audio data from multiple sources; and
verifying presence of a keyword by processing buffered data from multiple sources using the HKDE.

20. The method of claim 19, further comprising determining whether the audio data includes a keyword based on whether a confidence level with which the keyword is detected satisfies a condition.
